(19) United States
(12) Patent Application Publication
(10) Pub. No.: US 2006/0132505 A1
(43) Pub. Date: Jun. 22, 2006

(54) Image display apparatus for displaying screen of personal computer and method thereof

(75) Inventor: Su-won Shin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/155,592

(22) Filed: Jun. 20, 2005

(30) Foreign Application Priority Data
Dec. 16, 2004 (KR) 10-2004-0106711

(51) Int. Cl. G09G 5/00

(52) U.S. Cl. 345/638

(57) ABSTRACT

An image display apparatus for displaying a screen of a personal computer (PC) and a method for displaying the PC screen. The image display apparatus includes a connect section for providing an interface to a PC to receive a first video and a second video from the PC that displays at least one of the first video and the second video; a controller for controlling to mask the first video among the videos received through the connect section; and a masking processor for masking the first video. Accordingly, it is easy and convenient to change the size and the location of the PC screen. As the TV screen is displayed as the background of the PC screen, the user can view the TV and operate the PC tasks without the limitation on the screen size.

### CROSS-REFERENCE TO RELATED APPLICATIONS

This application claims priority from Korean Patent Application No. 10-2004-0106711 filed on Dec. 16, 2004 in the Korean Intellectual Property Office, the entire disclosure of which is incorporated herein by reference.

### BACKGROUND OF THE INVENTION

1. Field of the Invention

Apparatuses and methods consistent with the present invention relate to displaying a screen of a personal computer (PC), and more particularly, to replacing a background with a currently displayed image among images input from a PC to an image display apparatus when connecting to the PC through an external input, and displaying the image of the PC.

2. Description of the Related Art

Image display apparatuses display video images received through an antenna or a cable, and video images stored in recording media. Typically, the image display apparatuses include video cassette recorders (VCRs), digital versatile disk (DVD) players, compact disk (CD) players, hard disk drive (HDD) players, camcorders, digital cameras, mobile phones, personal digital assistants (PDAs), televisions (TVs), set-top boxes, and personal computers (PCs).

Recently, the development of multimedia technology enables image display apparatuses to connect to various multimedia devices through cables and to provide multimedia functions for displaying video, audio, sound, and text received from external sources. The multimedia devices, which provide the multimedia function, include the image display apparatuses. Thus, it is possible to interconnect the image display apparatuses.

As the image display apparatuses attain improved functions and improved performance, new image display apparatuses have been developed to have a picture-in-picture (PIP) function used to receive at least two video signals and to display the at least two video signals on a single screen.

In further detail, the PIP function displays two video signals simultaneously by displaying a large-sized screen as a main screen and a small-sized screen as a subscreen superimposed on the main screen. While displaying a program of a first video signal, if the PIP function is selected and second video signal is received, the first video signal is displayed on the main screen and the second video signal is displayed on the subscreen. Upon executing the PIP function, the subscreen is displayed on a certain region of the main screen. Users can change regions and sizes of the main screen and the subscreen, and the video signals to be displayed.

The following explains a PC as a multimedia device, and a television (TV) as an image display apparatus, by way of example. FIG. 1 depicts a connection between a PC and a general image display apparatus. In FIG. 1, the PC 10, which is an exemplary multimedia device, is connected to the TV 100, which is an exemplary image display apparatus, through a cable 50.

A digital video interface (DVI) can be adopted as an interface to connect the PC 10 and the TV 100. The DVI is a specification created by the Digital Display Working Group (DDWG) to accommodate an analog monitor and a digital monitor with a single connector. The DVI converts an input digital signal to an analog signal. Upon receiving the digital signal from the PC 10 through the cable 50, the TV 100 converts the input digital signal to the analog signal by means of the DVI and displays the converted analog signal.

In the related art, the TV 100 connectable to the PC 10 uses the PIP function to display images input from the PC 10. In particular, the PC 10 and the TV 100 are interconnected through the cable 50. The PC 10 inputs its image as the digital signal to the TV 100 through the cable 50. Upon receiving the PC image as the digital signal, the TV 100 converts the digital signal to the analog signal according to the DVI. The TV 100 displays the converted PC image using the PIP function.

FIGS. 2A to 2F depict examples of display of the PC screen of the conventional image display apparatus. FIG. 2A shows a general TV screen and FIG. 2B shows a PC screen. The general TV screen of FIG. 2A displays a video, and the PC screen of FIG. 2B displays a window, a plurality of icons, and a background. When the PC 10 inputs the PC screen of FIG. 2B to the TV 100, the TV 100 simultaneously displays the TV screen of FIG. 2A as the main screen and the input PC screen of FIG. 2B as the subscreen according to the PIP function. As shown in FIG. 2C, the TV 100 simultaneously displays the PC screen of FIG. 2B as the subscreen on a lower right region of the TV screen of FIG. 2A which is the main screen. As shown in FIG. 2D, the TV 100 simultaneously displays the PC screen as the subscreen of FIG. 2B on an upper right region of the TV screen of FIG. 2A which is the main screen. As shown in FIG. 2E, the TV 100 simultaneously displays the TV screen of FIG. 2A as the subscreen and the PC screen of FIG. 2B as the main screen. As shown in FIG. 2F, the screen of TV 100 is split into halves to display the TV screen on the left and the PC screen on the right.

In view of the related art, there is a limit when changing the size and the location of the subscreen. As the subscreen hides a portion of the main screen, users experience inconvenience when watching the TV or using the PC. In addition, due to the limited size of the entire screen, at least one of the main screen and the subscreen is too small to clearly display the image.

### SUMMARY OF THE INVENTION

The present invention provides an image display apparatus for efficiently displaying an PC screen on a TV screen when the PC screen is received from outside.

According to an aspect of the present invention, an image display apparatus comprises a connect section for providing an interface to a personal computer (PC) to receive a first video and a second video from the PC that displays at least one of the first video and the second video; a controller for controlling to mask the first video among the videos received through the connect section; and a masking processor for masking the first video.

The first video may be a background of the PC, and the second video may be at least one of a plurality of icons, a task bar, and a window of the PC.

The masking processor may replace the masked first video with a third video.

The controller may control to display the second video on the replaced third video.

The third video may be one of a tuned video and videos provided from at least one of a VCR, a DVD player, a CD player, an HDD player, a camcorder, a digital camera, a mobile phone, and a PDA that are connectable.

The image display apparatus may further include a display section for displaying the second video on the third video.

The connect section may provide an interface for a digital display connection to interface with the PC.

The image display apparatus may further include a key input section for changing a size and a location of the plurality of icons and the window included in the second video.

According to another aspect of the present invention, a method is provided for displaying a PC screen at an image display apparatus, the method comprising: providing an interface to a personal computer (PC) to receive a first video and a second video from the PC that displays at least one of the first video and the second video; and masking the first video among the videos received through the interface.

The first video may be a background of the PC, and the second video may be at least one of a plurality of icons, a task bar, and a window of the PC.

The masked first video may be replaced with a third video.

The third video may be one of a tuned video and videos provided from at least one of a VCR, a DVD player, a CD player, an HDD player, a camcorder, a digital camera, a mobile phone, and a PDA that are connectable to the image display apparatus.

The method may further include displaying the second video on the replaced third video.

The provided interface may be an interface for a digital display connection.

A size and a location of the plurality of icons and the window included in the second video are changeable.

### BRIEF DESCRIPTION OF THE DRAWINGS

The above and other aspects of the present invention will become apparent and more readily appreciated from the following description of exemplary embodiments, taken in conjunction with the accompanying drawing figures of which:

FIG. 1 is a diagram of a connection between a PC and a conventional image display apparatus;

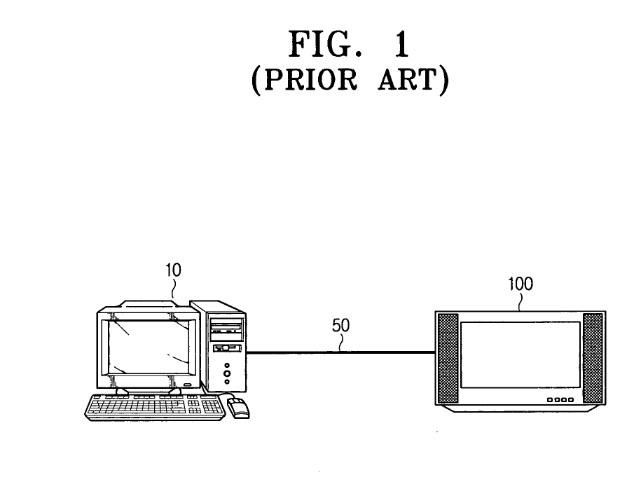

FIGS. 2A to 2F are examples of displaying a PC screen on the conventional image display apparatus;

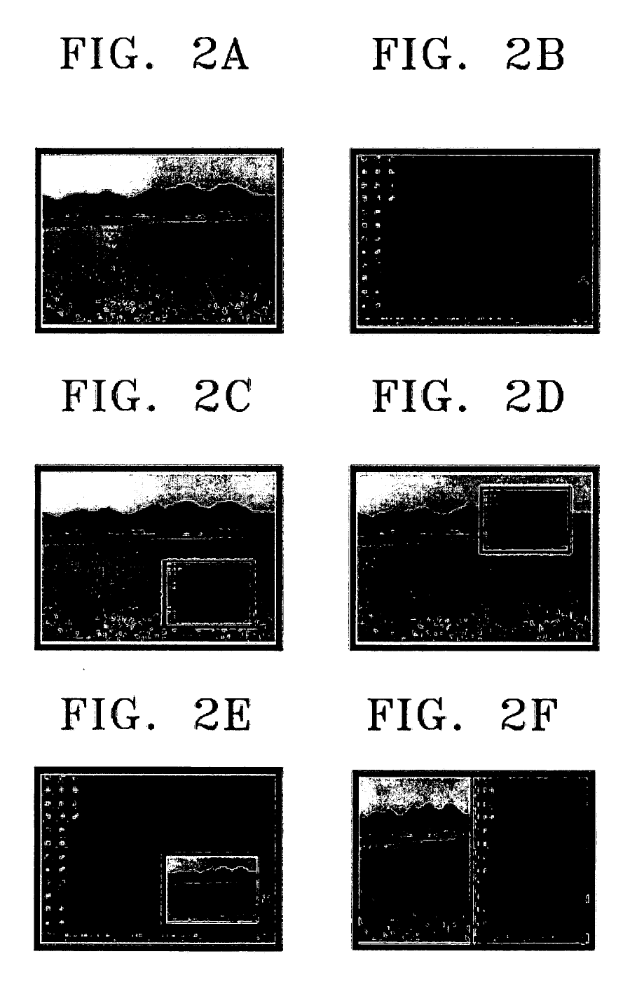

FIG. 3 is a block diagram of an image display apparatus according to an exemplary embodiment of the present invention;

FIG. 4 is a diagram of PC screens displayed on the image display apparatus according to an exemplary embodiment of the present invention;

FIG. 5 is a flowchart of a method for displaying the PC screen on the image display apparatus of FIG. 3; and

FIGS. 6A and 6B are examples of displaying the PC screen on the image display apparatus according to an exemplary embodiment of the present invention.

### DETAILED DESCRIPTION OF EXEMPLARY EMBODIMENTS OF THE PRESENT INVENTION

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

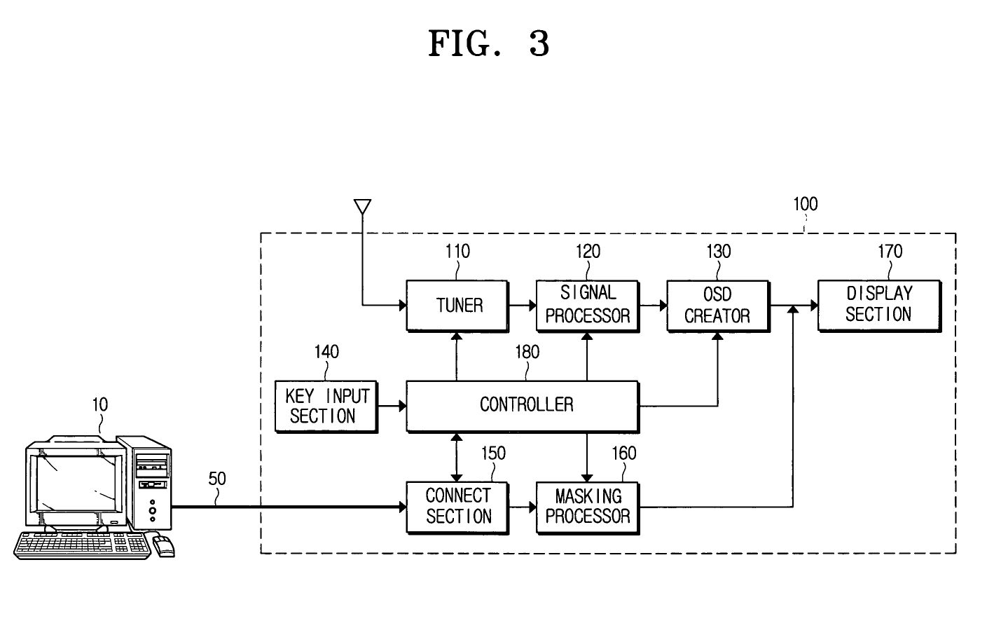

FIG. 3 is a block diagram of an image display apparatus according to an exemplary embodiment of the present invention.

Referring now to FIG. 3, a personal computer (PC) 10 is connected to a TV 100, which is an example of the image display apparatus according to an exemplary embodiment of the present invention, through a cable 50. The TV 100 includes a tuner 110, a signal processor 120, an on-screen display (OSD) creator 130, a key input section 140, a connect section 150, a masking processor 160, a display section 170, and a controller 180.

If a user selects a broadcast channel, the tuner 110 receives a video signal of the selected broadcast signal. The signal processor 120 processes the video signal received through the tuner 110 to be displayable on a TV screen.

The OSD creator 130 creates an OSD menu enabling a user to input a command from outside. More specifically, the OSD creator 130 creates an OSD menu to process the PC screen to be displayed, and controls processing of the created OSD menu at the signal processor 120 and display of the OSD menu in addition to a displayed video on the TV screen. The OSD menu created at the OSD creator 130 includes options to set a masking mode, a picture-in-picture (PIP) mode, a size of a window and a plurality of icons that are displayed on the PC screen, and a location of the window and the icons.

The key input section 140 enables the user to externally input a command. The user selects an intended broadcast channel via the key input section 140. Using the key input section 140, the user selects at least one of the masking mode and the PIP mode in the OSD menu created by the OSD creator 130. If the masking mode is selected, the user sets the size and the location of the window and the plurality of icons that are displayed on the PC screen, using the key input section 140.

The connect section 150 connects the PC 10 to the TV 100. Upon connecting to the PC 10, the connect section 150 receives from the PC 10 a digital PC screen which is set to a specific color rarely used. The connect section 150 converts the input digital PC screen to an analog PC screen according to a DVI.

The masking processor 160 masks the background set to a specific color in the PC screen converted to the analog PC screen, with the video processed by the signal processor 120. An exemplary masking is a blue screen function used for weather forecasts, which replaces a specific color with another image. The masking processor 160 replaces the background set to a specific color, excluding the window, the plurality of icons, and a task bar in the PC screen, with the processed video. Hence, the processed video is displayed as the background of the PC screen, in which the window, the icons, and the task bar are positioned.

The display section 170 displays the video processed by the signal processor 120 and the masked PC screen. In addition, the display section 170 displays the OSD menu that is created by the OSD creator 130 according to the user's command using the key input section 140.

The controller 180 controls the tuner 110 to receive the video signal of the broadcast channel selected using the key input section 140. Upon receiving the video signal, the controller 180 controls the signal processor 120 to signal-process the received video signal to for display.

The controller 180 detects the connection to the PC 10 through the connect section 150. Upon the detection of the PC connection, the controller 180 controls the connect section 150 to convert the digital PC screen, which is set to the specific color and received from the PC 10, to the analog signal.

When the user's command is input through the key input section 140, the controller 180 controls the OSD creator 130 to create the OSD menu. The controller 180 determines whether the user selects the masking mode through the key input section 140 in the created OSD menu. If the masking mode is selected, the controller 180 controls the masking processor 160 to mask the background set to the specific color in the analog PC screen, with the video signal processed by the signal processor 120. The controller 180 controls the display section 170 to display the processed video signal and the masked PC screen.

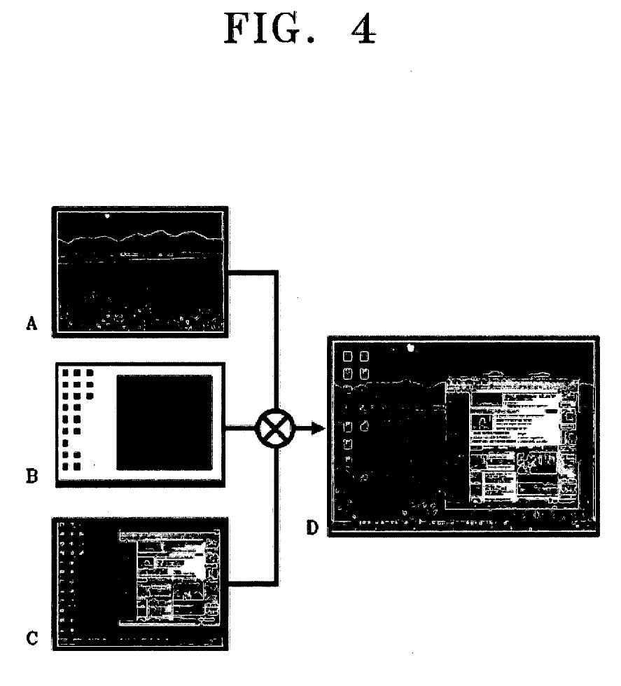

FIG. 4 depicts how to display the PC screen on the image display apparatus according to an exemplary embodiment of the present invention.

In FIG. 4, a screen A is the TV screen which displays the video signal processed by the signal processor 120. A PC screen C includes the plurality of icons and the window against the background being set to a specific color. A screen B is a masking window of the background being set to the specific color, excluding the plurality of icons, the task bar, and the window in the PC screen.

The masking processor 160 masks the video signal displayed on the TV screen A with the PC screen C under the control of the controller 180. In further detail, the masking processor 160 covers the PC screen C with the masking window B. The masking window B covers the plurality of icons, the task bar, and the window in the PC screen C, and only the background set to the specific color remains. The masking processor 160 replaces the remaining background with the video signal displayed on the TV screen A. A screen D is the result screen masked and displayed by the display section 170 of the TV 100. In the result screen D, the display section 170 of the TV 100 displays the plurality of icons, the window, and the task bar included in the PC screen C, and the video as the background of the PC screen. Accordingly, the user can not only view the video but also operate the PC tasks.

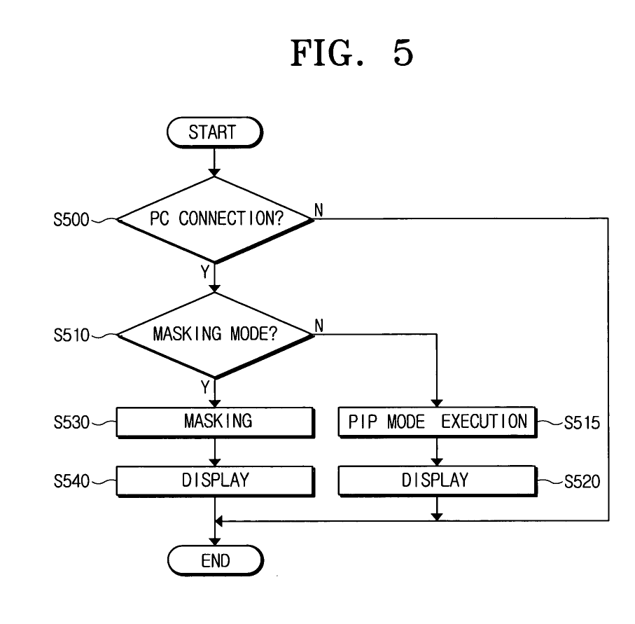

FIG. 5 is a flowchart explaining the PC screen display method of the image display apparatus according to an exemplary embodiment of the present invention.

Referring to FIG. 5, the controller 180 determines whether the PC 10 is connected (S500). Upon detecting the connect signal from the PC 100 through the connect section 150, the controller 180 determines the connection to the PC 10.

Upon connecting to the PC 10, the controller 180 determines whether the masking mode is selected (S510). When the user selects the masking mode using the key input section 140 in the OSD menu created by the OSD creator 130, a masking mode select signal is provided to the controller 180. The controller 180 determines the selection of the masking mode according to the received masking mode select signal. The masking mode is a mode for replacing the video processed by the signal processor 120 with the background of the PC screen input through the connect section 150 and displaying a result screen.

If the masking mode is not selected according to the determination, the controller 180 executes the PIP mode (S515). The PIP mode is a mode for displaying the processed video and the input PC screen on the main screen and on the subscreen, respectively.

By executing the PIP mode, the controller 180 controls to display the processed video on the main screen and the input PC screen on the subscreen (S520).

If the masking mode is selected at operation S510, the controller 180 controls the masking processor 160 to mask the processed video signal and the input PC screen (S530). The masking processor 160, under the control of the controller 180, replaces the processed video signal with the background which is set to the specific color in the input PC screen. As the masking has been described above with reference to the drawings, further descriptions are omitted for brevity.

The controller 180 controls to display the masked PC screen on the display section 170 (S540). The video signal is displayed as the background of the PC screen on the display section 170.

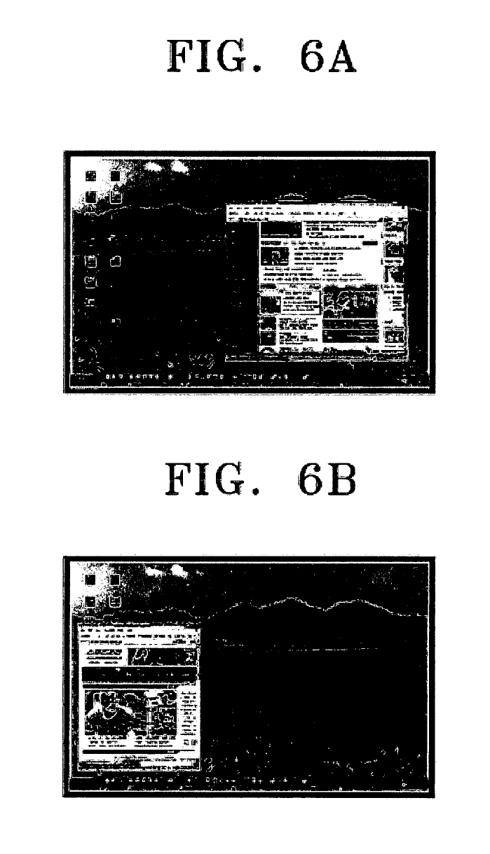

FIGS. 6A and 6B are examples of the PC screen display of the image display apparatus according to an exemplary embodiment of the present invention.

In FIGS. 6A and 6B, the PC screen display method of the image display apparatus displays the masked screen on the display section 170. As shown in FIG. 6A, a screen is displayed after masking the background of the PC screen, which is input from an external source, with the video signal displayed on the display section 170 of the TV 100. The plurality of icons, the task bar, and the window in the PC screen are displayed as in the PC screen, and the video of the TV 100 is displayed as the background of the PC screen.

As shown in FIG. 6B, a screen is displayed after masking the background of the PC screen, which is input from outside, with the video signal displayed on the display section 170 of the TV 100. The user may set the size and the location of the window of the PC screen being displayed after the masking, by means of the key input section 140. The masked and displayed screen enables the user to operate the PC tasks and to view the video signal of the TV 100. In addition, the user can select other broadcast channels using the key input section 140.

It has been illustrated that the background of the PC screen is masked with the video signal received by the TV and the masked screen is displayed, but not limited to this video signal. It is possible to mask the background of the PC with a video signal input from a VCR, a DVD player, a CD player, an HDD player, a camcorder, a digital camera, a mobile phone, and a PDA that are connectable to the TV.

In light of the foregoing as set forth, it is easy and convenient to change the size and the location of the PC screen. As the TV screen is displayed as the background of the PC screen, the user can view the TV and do the PC tasks without the limitation on the screen size.

Although exemplary embodiments of the present invention have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An image display apparatus comprising:
a connect section which provides an interface to a personal computer (PC) to receive a first video signal and a second video signal from the PC that displays at least one of the first video signal and the second video signal;
a masking processor which masks the first video signal received through the connect section; and
a controller which controls the masking processor to mask the first video signal.

2. The image display apparatus of claim 1, wherein the first video signal corresponds to a background of the PC, and the second video signal corresponds to at least one of a plurality of icons, a task bar, and a window of the PC.

3. The image display apparatus of claim 1, wherein the masking processor replaces the first video signal which is masked with a third video signal.

4. The image display apparatus of claim 1, wherein the controller controls display of the second video signal on the third video.

5. The image display apparatus of claim 3, wherein the third video signal is one of a tuned broadcast video signal and a video signal provided from a video cassette recorder (VCR), a digital versatile disk (DVD) player, a compact disk (CD) player, a hard disk drive (HDD) player, a camcorder, a digital camera, a mobile phone, or a personal digital assistant (PDA) that are connectable to the image display apparatus.

6. The image display apparatus of claim 4, further comprising a display section which displays the second video signal on the third video signal.

7. The image display apparatus of claim 1, wherein the connect section provides an interface for a digital display connection to interface with the PC.

8. The image display apparatus of claim 2, further comprising a key input section which changes a size and a location of the plurality of icons and the window included in the second video signal.

9. A method for displaying a personal computer (PC) screen on an image display apparatus, the method comprising:
receiving at an interface to a PC a first video signal and a second video signal from the PC that displays at least one of the first video signal and the second video signal; and
masking the first video signal received through the interface.

10. The method of claim 9, wherein the first video signal corresponds to a background of the PC, and the second video signal corresponds to a at least one of a plurality of icons, a task bar, and a window of the PC.

11. The method of claim 9, wherein the first video signal which is masked is replaced with a third video signal.

12. The method of claim 11, wherein the third video signal is one of a tuned broadcast video signal and a video signal provided from a video cassette recorder (VCR), a digital versatile disk (DVD) player, a compact disk (CD) player, a hard disk drive (HDD) player, a camcorder, a digital camera, a mobile phone, or a personal digital assistant (PDA) that are connectable to image display apparatus.

13. The method of claim 11, further comprising displaying the second video signal on the third video signal.

14. The method of claim 9, wherein the interface is an interface for a digital display connection.

15. The method of claim 10, wherein a size and a location of the plurality of icons and the window included in the second video signal are changeable.
